(19) United States
(12) Patent Application Publication
(10) Pub. No.: US 2006/0151570 A1
(43) Pub. Date: Jul. 13, 2006

(54) Ultrasonic bonding device, information recording medium manufacturing apparatus, ultrasonic bonding method, object, and cartridge case

(75) Inventors: Shintaro Shinkawa, Tokyo (JP); Kenji Kotegawa, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 10/563,423

(22) PCT Filed: Jul. 9, 2004
(86) PCT No.: PCT/JP04/09798

§ 371 Date: Jan. 5, 2006

(30) Foreign Application Priority Data
Jul. 10, 2003 (JP) 2003-194964

(51) Int. Cl. B23K 5/20; B23K 1/06; B23K 20/10

(52) U.S. Cl. 228/1.1; 228/110.1

(57) ABSTRACT

Snapping off and excessive protruding are prevented for parts formed by melted material.

An ultrasonic vibrator 3, a horn 4 whose contact surface that contacts a front end portion of an attachment boss 22a of a recording medium case (an upper case 11a and a lower case 11b) is subjected to a matte finishing process and transmits ultrasound generated by the ultrasonic vibrator 3, and a moving mechanism 2 that moves the horn 4 in a direction toward and away from the recording medium case are included. By doing so, it is possible to prevent the melted material from flowing out in a wide range across the contact surface and the formation of deep concaves at a part formed of melted material.

### TECHNICAL FIELD

The present invention relates to an ultrasonic welding apparatus, an information recording medium manufacturing apparatus, and an ultrasonic welding method, and also to an object and a cartridge case that have been subjected to a welding process using such apparatuses and method.

### BACKGROUND ART

As one example of this type of ultrasonic welding apparatus, Japanese Laid-Open Patent Publication No. H11-176132 discloses an ultrasonic welding apparatus (an ultrasonic welding horn (36)) constructed so as to be capable of fixing reel springs (28, 29) to an upper shell (21) of a tape cassette. In this case, the upper shell (21) and the reel spring (28), and the upper shell (21) and the reel spring (29) respectively compose pairs of objects to be fixed together by a method called welding (more specifically, crimping) using an ultrasonic welding apparatus. Out of these, the reel springs (28, 29) that are one object in each pair are components for preventing reels (26, 27) from rattling inside the cassette case and are formed of metal plates so as to be capable of elastic deformation, with base end portions (28b, 29b) thereof being fixed to the upper shell (21) as the other object in each pair and front end portions (28a, 29a) thereof contacting central portions of the reels (26, 27) to elastically press the reels (26, 27). The ultrasonic welding apparatus that fixes the reel springs (28, 29) to the upper shell (21) is constructed so that ultrasound generated by vibration by an ultrasonic vibrator is transmitted via an ultrasonic welding horn (36) to the upper shell (21) (more specifically, to crimping bosses (33) of the upper shell (21)) to melt the crimping bosses (33) and thereby fix the reel springs (28, 29).

When fixing the reel springs (28, 29) to the upper shell (21) using this ultrasonic welding apparatus, first, the crimping bosses (33) formed on an inner wall surface of the upper shell (21) are inserted through crimping holes (31) formed in the base end portions (28b, 29b) of the reel springs (28, 29). Next, while the ultrasonic vibrator is being caused to generate ultrasound, the ultrasonic horn is moved (lowered) toward the crimping bosses (33) by a moving mechanism so that base surfaces of crimping concaves (36a) (the lower surface of the ultrasonic welding horn (36)) contact edge portions of the crimping holes (31). At this time, the ultrasound generated by the vibration of the ultrasonic vibrator is transmitted to the front ends of the crimping bosses (33) via the ultrasonic welding horn (36) to melt the front ends. When doing so, the front ends of the melted crimping bosses (33) are crushed so as to be pressed outward inside the crimping concaves (36a). As a result, head portions (33a) are formed at the front ends of the crimping bosses (33). These head portions (33a) restrict the detachment of the reel springs (28, 29), and by forming the head portions (33a), the fixing of the reel springs (28, 29) to the upper shell (21) is completed.

Patent Document 1

Japanese Laid-Open Patent Publication No. H11-176132 (pages 3 to 5)

### DISCLOSURE OF THE INVENTION

Problem to be Solved by the Invention

By investigating the conventional ultrasonic welding apparatus described above, the present inventors discovered the following problem. That is, with the conventional ultrasonic welding apparatus, by lowering the ultrasonic welding horn (36) while transmitting ultrasound via the ultrasonic welding horn (36), the front ends of the crimping bosses (33) are melted to form the head portions (33a: “fixing head portions”) inside the crimping concaves (36a). When doing so, since the crimping concaves (36a) of the ultrasonic welding horn (36) are formed as circular concaves with a certain depth, hemispherical head portions (33a) formed by pressing out inside the crimping concaves (36a) protrude greatly inside the cassette case. Accordingly, when fixing the reel springs (28, 29) to the upper shell (21) using the conventional ultrasonic welding apparatus (the ultrasonic welding horn (36)), there is the risk of the reels (26, 27) contacting the front ends of the head portions (33a).

On the other hand, by forming the head portions by crushing the front ends of the crimping bosses (33) using an ultrasonic welding horn (hereinafter, simply “horn”) whose contact surface that contacts the crimping bosses (33) is flat in place of the ultrasonic welding horn (36) in which the crimping concaves (36a) are formed, it is possible to fix the reel springs (28, 29) without the head portions greatly protruding inside the cassette case. However, to efficiently transmit the ultrasound to the crimping bosses 33 with this kind of horn, as shown by the ultrasonic welding horn 51 in FIG. 8, for example, a mesh-like pattern of grooves (fine convexes and concaves) is formed in a contact surface 51a. Accordingly, when manufacturing the tape cassette described above, as shown in FIG. 9, concaves (33c) with a complementary shape to the mesh-like pattern of the contact surface 51a are formed in the head portions 33b formed by crushing the front ends of the crimping bosses (33) using the ultrasonic welding horn 51.

In this case, the depth of the mesh-like pattern (grooves) formed in the contact surface 51a is normally set at around 0.2 mm. Accordingly, the concaves 33c of the head portions 33b formed by pressing the contact surface 51a are formed with a depth D of around 0.2 mm. On the other hand, to reliably fix the reel springs (28, 29) onto the upper shell (21) without the head portions 33b greatly protruding, it is necessary to set the thickness T1 of the head portion 33b in a range of around 0.35 to 0.4 mm. However, if the head portions 33b are formed with a thickness T1 of 0.35 mm for example using the ultrasonic welding horn 51, the thickness T between the base surfaces of the concaves 33c and the reel springs (28, 29) becomes extremely thin at around 0.15 mm. For this reason, when the reel springs (28, 29) are fixed to the upper shell (21) using the ultrasonic welding horn 51 in whose contact surface 51a grooves are formed in a mesh-like pattern, the head portions 33b is susceptible to snapping off at the positions of the concaves 33c and therefore there are the risks of the reel springs (28, 29) becoming detached and of the magnetic tape becoming damaged by broken fragments of the head portions 33b.

Also, by crushing the front ends of the crimping bosses (33) using an ultrasonic welding horn in whose contact surface grooves have not been formed, it is possible to fix the reel springs (28, 29) without forming concaves 33c in the head portions. However, when an ultrasonic welding horn with no fine convexes and concaves such as grooves formed on the contact surface is used, when the front ends of the crimping bosses (33) melt, the melted resin material flows out in a wide range across the contact surface, and as shown in FIG. 10, head portions 33d are formed with an extremely slim thickness T1a. Since the head portions 33d become thinner toward the outer edge parts thereof, the outer edge parts are especially susceptible to snapping. For this reason, when the reel springs (28, 29) are fixed to the upper shell (21) using an ultrasonic welding horn in whose contact surface fine convexes and concaves have not been formed, there are the risks of the reel springs (28, 29) becoming detached and of the magnetic tape becoming damaged by broken fragments of the head portions 33d.

The present invention was conceived to solve the problems described above, and it is a principal object of the present invention to provide an ultrasonic welding apparatus, an information recording medium manufacturing apparatus, and an ultrasonic welding method where parts formed of melted material do not snap or excessively protrude, and also an object and cartridge case formed using such apparatuses and method.

Means for Solving the Problems

The ultrasonic welding apparatus according to the present invention includes: an ultrasonic vibrator; an ultrasonic horn whose contact surface that contacts an object is subjected to a matte finishing process and which transmits ultrasound generated by the ultrasonic vibrator; and a moving mechanism that moves the ultrasonic horn in a direction toward and away from the object.

In this case, the contact surface of the ultrasonic welding horn is subjected to a matte finishing process so that the ten-point average roughness (JIS B0601-1994) thereof is in a range of 10 μm to 25 μm, inclusive.

Also, the ultrasonic welding apparatus is constructed so that by placing the contact surface of the ultrasonic horn in contact with a front end portion of a welding convex portion formed on the object in a state where the welding convex portion has been inserted through a through hole formed in another object and causing the moving mechanism to move the horn toward the welding convex portion while having the ultrasonic vibrator generate the ultrasound, the front end portion is melted and crushed into a plate-like shape to form a fixing head portion to fix the other object to the object.

An information recording medium manufacturing apparatus according to the present invention includes: an ultrasonic vibrator; an ultrasonic horn whose contact surface that contacts an object is subjected to a matte finishing process and which transmits ultrasound generated by the ultrasonic vibrator; and a moving mechanism that moves the ultrasonic horn in a direction toward and away from the object, wherein the information recording medium manufacturing apparatus is capable of manufacturing a cartridge-type information recording medium by placing the contact surface of the ultrasonic horn in contact with a front end portion of a welding convex portion formed on a recording medium case as the object in a state where the welding convex portion has been inserted through a through hole formed in a recording medium component and causing the moving mechanism to move the horn toward the welding convex portion while having the ultrasonic vibrator generate the ultrasound and melt and crush the front end portion into a plate-like shape to form a fixing head portion and thereby fix the recording medium component to the recording medium case.

An ultrasonic welding method according to the present invention fixes an object to another object by placing a contact surface of an ultrasonic horn that has been subjected to a matte finishing process in contact with a front end portion of a welding convex portion formed on the object in a state where the welding convex portion has been inserted through a through hole formed in the other object and moving the ultrasonic horn toward the welding convex portion while applying ultrasound to the welding convex portion via the ultrasonic horn to melt and crush the front end portion of the welding convex portion into a plate-like shape to form a fixing head portion.

An object according to the present invention has a matte pattern formed by a welding process on part of a surface thereof.

A cartridge case according to the present invention includes a recording medium case as an object that has a matte pattern formed by a welding process on part of a surface thereof.

In this case, the matte pattern is formed with a surface of a boss for fixing a spring as the surface.

Effect of the Invention

According to the ultrasonic welding apparatus according to the present invention, by including an ultrasonic horn whose contact surface that contacts an object is subjected to a matte finishing process and which transmits ultrasound generated by the ultrasonic vibrator to melt the object, it is possible to form a fixing head portion, for example, by transmitting ultrasound from an ultrasonic generator to one of the objects to melt the object while avoiding a flowing out of melted material over a wide range across the contact surface and the formation of deep concaves in the fixing head portion. Accordingly, it is possible to prevent the part formed of the melted material from excessively protruding or snapping off, and as a result, it is possible to fix the other object to the object using the part formed by the melted material.

According to the ultrasonic welding apparatus according to the present invention, by using the ultrasonic horn whose contact surface has been subjected to a matte finishing process to make a ten-point average roughness thereof in a range of 10 μm to 25 μm, inclusive, it is possible to reliably avoid the formation of deep concaves at a part formed of the melted material while reliably preventing the melted material from flowing out in a wide range across the contact surface.

According to the ultrasonic welding apparatus, information recording medium manufacturing apparatus, and ultrasonic welding method according to the present invention, by placing the contact surface of the ultrasonic horn in contact with a front end portion of a welding convex portion formed on one object in a state where the welding convex portion has been inserted through a through hole formed in another object and causing the moving mechanism to move the horn toward the welding convex portion while having the ultrasonic vibrator generate ultrasound, the front end portion is melted and crushed into a plate-like shape to form a fixing head portion to fix the other object to the object. Since it is possible to avoid the flowing out of the melted material in a wide range across the contact surface and the formation of deep concaves in the fixing head portion, it is possible to reliably fix the other object to the object while preventing the fixing head portion from protruding and avoiding the formation of deep concaves in the fixing head portion.

According to the object and cartridge according to the present invention, since a matte pattern is formed by a welding process on part of a surface, it is possible to avoid the flowing out of melted material in a wide range across the contact surface of an ultrasonic horn and the formation of deep concaves in a part (fixing head portion) formed by the melted material. Since it is possible to prevent the part formed by the melted material from greatly protruding or snapping off, it is possible to reliably fix the other object to the object using the part formed by the melted material while avoiding interference between the part formed by the melted material and other members.

According to the cartridge according to the present invention, since the matte pattern is formed by a welding process on a surface of a boss for fixing a spring, it is possible to avoid the flowing out of melted material in a wide range across the contact surface of an ultrasonic horn and the formation of deep concaves in a part (fixing head portion) formed by the melted material. Since it is possible to prevent the fixing head portion formed by the melted material from greatly protruding or snapping off, it is possible to reliably fix the spring to the boss while avoiding a situation where a magnetic tape is damaged due to contacting the fixing head portion and a situation where the magnetic tape is damaged by broken fragments of the fixing head portion.

### BEST MODE FOR CARRYING OUT THE INVENTION

Preferred embodiments of an ultrasonic welding apparatus, an information recording medium manufacturing apparatus, an ultrasonic welding method, an object, and a cartridge case according to the present invention will now be described with reference to the attached drawings.

First, the constructions of an information recording medium manufacturing apparatus 101 and a tape cartridge 10 assembled using the information recording medium manufacturing apparatus 101 will be described with reference to the drawings.

The information recording medium manufacturing apparatus (hereinafter simply “manufacturing apparatus”) 101 includes a component conveying device 102, a conveying mechanism 103, and an ultrasonic welding apparatus 1 and is constructed so as to be capable of manufacturing the tape cartridge 10 shown in FIG. 3. In this case, the ultrasonic welding apparatus 1 is a welding apparatus (an apparatus that carries out a welding process) that fixes, to recording medium cases (an upper case 11a and a lower case 11b) as one object in each pair of welded objects, spring members 18 that are the other objects in the pairs of welded objects according to a method called welding, as part of the assembly of the tape cartridge 10. As shown in FIG. 1, the ultrasonic welding apparatus 1 includes a moving mechanism 2, an ultrasonic vibrator 3, an ultrasonic horn (hereinafter simply “horn”) 4, a control unit 5, and a base 6. Under the control of the control unit 5, the moving mechanism 2 moves the ultrasonic vibrator 3 and the horn 4 in a direction toward and away from the recording medium cases. Also under the control of the control unit 5, the ultrasonic vibrator 3 generates ultrasound of around 30 kHz, for example, to cause longitudinal vibration of the horn 4.

The horn 4 is a jig that transmits the ultrasound generated by the vibration of the ultrasonic vibrator 3 to the recording medium case (the upper case 11a and the lower case 11b) and as shown in FIG. 2, is formed with a substantially conical overall shape so as to be able to efficiently transmit the ultrasound. A base end portion 4a of the horn 4 is connected to (fixed to) the ultrasonic vibrator 3 in a state where a contact surface 4c formed on a front end portion 4b of the horn 4 faces downward (toward the base 6). The contact surface 4c of the horn 4 is formed flat and to make a ten-point average roughness (JIS B0601-1994: hereinafter simply “surface roughness”) thereof in a range of 10 μm to 25 μm, inclusive (as one example, at 16.7 μm), the surface is subjected to a non-oriented delustering process (also referred to in this specification as a “matte finishing process” (fine-graining process)) where fine convexes and concaves are uniformly formed in the surface by an electrical discharge machining, for example. In this case, the surface roughness described above is found by carrying out a measuring process using a surface roughness measuring instrument (an SE-30H made by KOSAKA LABORATORY LTD.) at three positions on the contact surface 4c where the radius of curvature of the measuring stylus is set at 2 μm, the cutoff at 0.8 mm and the measured length at 2.5 mm, with the average then being calculated for the three positions. Note that the value is not limited to an average value and the surface roughness may be found by carrying out a measuring process at one freely chosen representative position on the contact surface 4c. In the same way, the processing method for the contact surface 4c is not limited to a discharging process so long as the surface roughness falls within the range given above, and as examples the matte finishing process may be carried out by a mechanical process such as a blasting process or a chemical process that uses various types of agent. In addition to controlling the moving mechanism 2 to move the ultrasonic vibrator 3 and the horn 4 (up-down movement), the control unit 5 controls the ultrasonic vibrator 3 to generate ultrasound. The base 6 is composed of conveying rails of the conveying mechanism 103, for example, and is formed so that the upper case 11a and the lower case 11b can be mounted thereupon.

The component conveying device 102 conveys the spring members 18 to be welded by the ultrasonic welding apparatus 1 and sets the spring members 18 on the cases 11a and 11b. The conveying mechanism 103 conveys the cases 11a and 11b to a work position of the component conveying device 102, conveys the cases 11a and 11b on which the setting of spring members 18 has been completed to a work position of the ultrasonic welding apparatus 1, and conveys the cases 11a and 11b on which the fixing (welding) of the spring members 18 has been completed to a work position of a next process.

On the other hand, the tape cartridge 10 is a single-reel cartridge-type magnetic recording medium (information recording medium) that can be used as a storage device for backing up recording data recorded by an electronic computer, for example, and as shown in FIG. 3, is constructed with a tape reel 12, a brake spring 13, a locking member 14, a brake releasing plate 15, a door member 16, and the like housed inside a case main body 11. In this case, a magnetic tape (not shown) is wound around the tape reel 12, and a leader pin 17 for withdrawing the magnetic tape from inside the case main body 11 during the recording and reproduction of recording data is fixed to an end of the magnetic tape. Note that since the forms, functions, and the like of the brake spring 13, the locking member 14, the brake releasing plate 15, and the door member 16 are well known, description thereof has been omitted for ease of understanding the present invention.

The case main body 11 includes the upper case 11a and the lower case 11b that can be fitted together. In this case, a cutaway part 21a that composes a tape withdrawal opening 21 is formed in one out of the four side plates erected on the four edges of a top plate of the upper case 11a. In the same way, a cutaway part 21b that together with the cutaway part 21a of the upper case 11a composes the tape withdrawal opening 21 is formed in one out of the four side plates erected on the four edges of a base plate 22 of the lower case 11b. Note that since the upper case 11a and the lower case 11b have substantially the same shapes and attachment structures for the spring members 18 described later, the lower case 11b is described below as a representative example and description of the upper case 11a is omitted.

As shown in FIG. 4, a spring member 18 described above that restricts withdrawal of the leader pin 17 from the case main body 11 is fixed in the periphery of the cutaway part 21b (the tape withdrawal opening 21) of the lower case 11b. In this case, the spring member 18 is formed by folding a strip-like elastic member (for example, a piece of metal) in a predetermined shape and a cylindrical part 18a that forms a through hole 18b shown in FIG. 5 is fixed to (welded to) the lower case 11b by the ultrasonic welding apparatus 1. Also, an attachment boss 22a (a “welding convex portion” for the present invention) for fixing the spring member 18 is erected on the base plate 22 of the lower case 11b. In this case, the attachment boss 22a is formed in a cylindrical shape and as shown in FIG. 5 is inserted through the through hole 18b formed by the cylindrical part 18a. Also, a fixing head portion (hereinafter simply “head portion”) 22b for restricting detachment (removal) of the spring member 18 is formed in the front end portion of the attachment boss 22a that protrudes from the through hole 18b by the ultrasonic welding apparatus 1 crushing the front end portion into a flat plate (one example of a plate-like shape).

Next, the method of fixing (welding) the spring member 18 to the lower case 11b by carrying out a welding process on the lower case 11b using the ultrasonic welding apparatus 1 of the manufacturing apparatus 101 will be described with reference to the drawings.

First, the component conveying device 102 conveys the spring member 18 and sets the spring member 18 on the lower case 11b. When doing so, as shown in FIG. 6, the component conveying device 102 sets the spring member 18 so that the attachment boss 22a of the base plate 22 passes through the through hole 18b of the cylindrical part 18a. Note that at the time when the spring member 18 is set on the lower case 11b, the horn 4 is not present at the position shown in FIG. 6. Next, the conveying mechanism 103 conveys the lower case 11b along the base 6 (the conveying rails) to below the horn 4. After this, the ultrasonic welding apparatus 1 starts the welding process. At this time, the control unit 5 controls the ultrasonic vibrator 3 to generate ultrasound and controls the moving mechanism 2 to move (lower) the ultrasonic vibrator 3 and the horn 4 toward the case main body 11, and as shown in FIG. 6, the contact surface 4c of the horn 4 is placed in contact with the front end surface (the “contact surface” for the present invention) of the attachment boss 22a. At this time, the ultrasound is transmitted from the ultrasonic vibrator 3 via the horn 4 to the attachment boss 22a and by doing so, the front end portion of the attachment boss 22a is melted.

Next, when the horn 4 has been lowered further by the moving mechanism 2, as shown in FIG. 7, the melted attachment boss 22a (resin material) is crushed by the horn 4 and is pressed outward across the contact surface 4c into a disc-like shape (a flat plate). At this time, unlike when a horn in whose contact surface fine convexes and concaves are not formed is used, the melted resin material is prevented from flowing out in a wide range across the contact surface 4c. In this case, when the surface roughness of the contact surface 4c is set at under 10 μm, there is the risk of the melted resin material flowing out in a wide range across the contact surface 4c. Accordingly, the surface roughness of the contact surface 4c should preferably be set at 10 μm or greater.

Next, the control unit 5 controls the ultrasonic vibrator 3 to stop the generation of ultrasound and also controls the moving mechanism 2 to move (raise) the ultrasonic vibrator 3 and the horn 4 away from the lower case 11b. When doing so, a flat plate-like head portion 22b is formed due to the melted resin material (the front end portion of the attachment boss 22a) having hardened. At this time, since the contact surface 4c is subjected to the so-called “matte finishing process”, unlike when a horn in whose contact surface grooves are formed in a mesh-like pattern, it is possible to form the head portion 22b without forming concaves that carry the risk of the head portion 22b snapping off. By doing so, detachment (removal) of the spring member 18 from the lower case 11b is restricted by the head portion 22b, thereby fixing the spring member 18. In this case, when the surface roughness of the contact surface 4c is set rougher than 25 μm, deep concaves are formed in the surface of the head portion 22b and therefore there is the risk of the head portion 22b being susceptible to snapping off. Accordingly, the surface roughness of the contact surface 4c should preferably be set no greater than 25 μm. After this, the tape cartridge 10 is manufactured by carrying out processes such as housing the tape reel 12 and the like and joining (screwing together) the upper case 11a and the lower case 11b.

In this way, the ultrasonic welding apparatus 1 and the manufacturing apparatus 101 are constructed so that the horn 4 whose contact surface 4c is formed flat and subjected to a matte finishing process melts the attachment boss 22a and crushes the attachment boss 22a to a flat plate to fix the spring members 18 to the upper case 11a and the lower case 11b, and unlike when using a horn in whose contact surface fine convexes and concaves are not formed, it is possible to avoid a situation where the melted attachment boss 22a flows out in a wide range. As a result, it is possible to prevent the head portion 22b from protruding significantly into the case main body 11 and also to fix the spring member 18 in a state where the head portion 22b is kept sufficiently thick. By doing so, it is possible to avoid a state where the magnetic tape contacts the head portion 22b and becomes damaged. Also, since the outer edge portion of the head portion 22b does not become very thin, it is possible to avoid a situation where the head portion 22b snaps off, and as a result it is possible to reliably fix the spring members 18 to the upper case 11a and the lower case 11b. Also, unlike when using a horn in whose contact surface grooves are formed in a mesh-like pattern, the spring members 18 can be fixed without forming deep concaves in the head portion 22b. By doing so, it is possible to avoid a situation where the head portion 22b snaps off, and as a result detachment of the spring members 18 can be avoided and damage to the magnetic tape due to broken fragments of the head portion 22b can also be avoided.

Also, according to the ultrasonic welding apparatus 1 and the manufacturing apparatus 101, by using the horn 4 whose contact surface 4c has been subjected to a matte finishing process so that the ten-point average roughness is in a range of 10 μm to 25 μm, inclusive, it is possible to reliably prevent the melted attachment boss 22a from flowing out in a wide range and the formation of deep concaves in the head portion 22b that makes the head portion 22b susceptible to snapping off. As a result, the spring members 18 can be more reliably fixed to the upper case 11a and the lower case 11b, and it is also possible to more reliably avoid damage to the magnetic tape by fragments of the head portion 22b.

Note that the present invention is not limited to the construction described above. For example, although an example where the spring members 18 are fixed (welded) as one object (“the other object”) in each pair of welded objects to the lower case 11b (and the upper case 11a) as the other objects (“one object”) in the pairs has been described for the above construction, the pairs of welded objects that can be fixed using the ultrasonic welding apparatus according to the present invention are not limited to the pair of the upper case 11a and a spring member 18 and the pair of the lower case 11b and a spring member 18, and include various other pairs of members. For example, during the manufacturing of a recording/reproduction head such as an optical head, a magneto-optical head, or a magnetic head, when crimping a boss formed on the head main body that is made of resin and constructs the head to fix a metal plate spring to the head main body, the present invention can be applied with the head main body as one object and the plate spring as another object in a pair of welded objects. Also, during the manufacturing of a piezo-resonator, when a piezoelectric element is held between a spacer made of resin and an earth terminal plate made of metal that compose the piezo-resonator by crimping a boss formed on the spacer to fix the earth terminal plate to the spacer, the present invention can be applied to a pair of welded objects where the spacer is one object and the earth terminal plate is the other object. Also, although an example where the horn 4 is caused to longitudinally vibrate using ultrasound of around 30 kHz when fixing the spring members 18 has been described for the above construction, the frequency and vibration direction of the ultrasound are not limited to such and can be changed as appropriate.

### INDUSTRIAL APPLICABILITY

As described above, according to the ultrasonic welding apparatus according to the present invention, by including an ultrasonic horn whose contact surface that contacts an object is subjected to a matte finishing process and which transmits ultrasound generated by an ultrasonic generator to the object to melt the object, it is possible to form a head portion of a boss, for example, by transmitting ultrasound from the ultrasonic generator to one object while preventing the melted material from flowing out in a wide area across the contact surface and preventing deep concaves from being formed at the positions formed of the melted material. By doing so, an ultrasonic welding apparatus where the positions (for example, head portions of bosses) formed by melted material do not protrude excessively or snap is realized.

### BRIEF DESCRIPTION OF THE DRAWINGS

FIG. 1 is a block diagram showing the construction of a manufacturing apparatus 101 (an ultrasonic welding apparatus 1) according to the present invention.

FIG. 2 is a front view of the horn 4 (left image) and a bottom view of the horn 4 (right image).

FIG. 3 is an exploded perspective view showing the construction of a tape cartridge 10.

FIG. 4 is a plan view of a periphery of a cutaway part 21b in a lower case 11b.

FIG. 5 is a cross-sectional view along a line A-A in FIG. 4.

FIG. 6 is a cross-sectional view showing a state where the horn 4 has been placed in contact with a front end surface of an attachment boss 22a of the lower case 11b when fixing a spring member 18.

FIG. 7 is a cross-sectional view of a state where the horn 4 has been lowered in the state shown in FIG. 6 and has crushed a front end portion of the attachment boss 22a (to form the head portion 22b).

FIG. 8 is a bottom view showing a conventional ultrasonic welding horn 51 when looking from a contact surface 51a side.

FIG. 9 is a cross-sectional view of a state where a front end portion of a crimping boss (33) has been crushed to form a head portion 33b by the ultrasonic welding horn 51.

FIG. 10 is a cross-sectional view of a state where a front end portion of a welding boss (33) has been crushed to form a head portion 33d by an ultrasonic welding horn in whose contact surface fine convexes and concaves have not been formed.

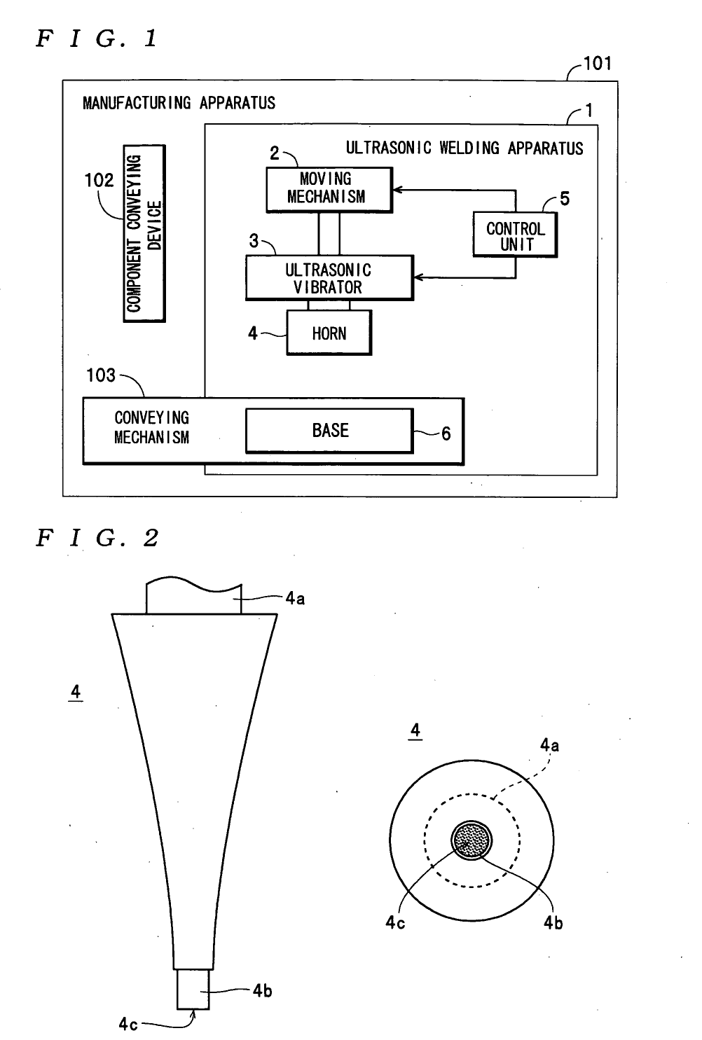

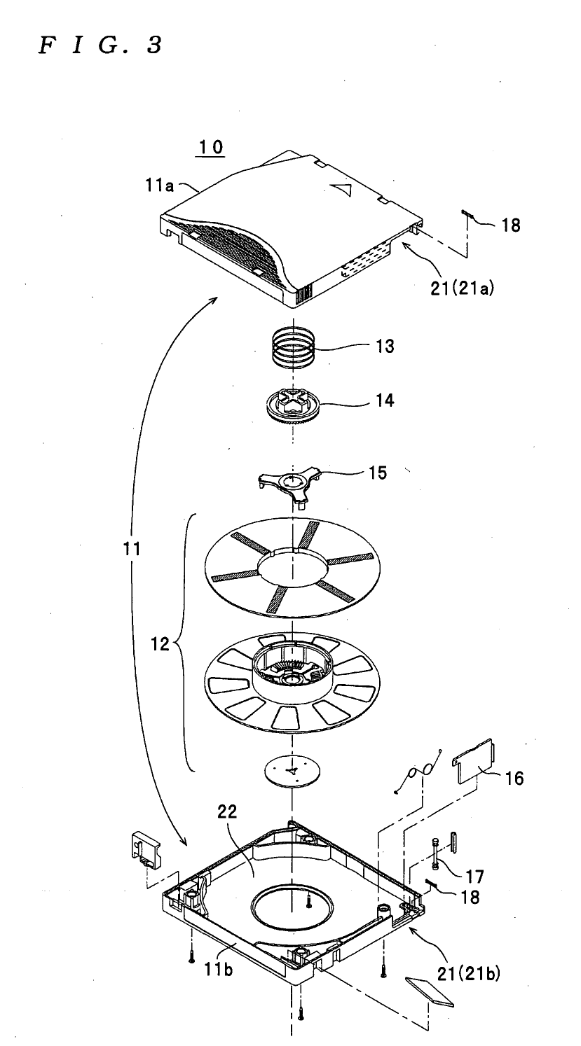

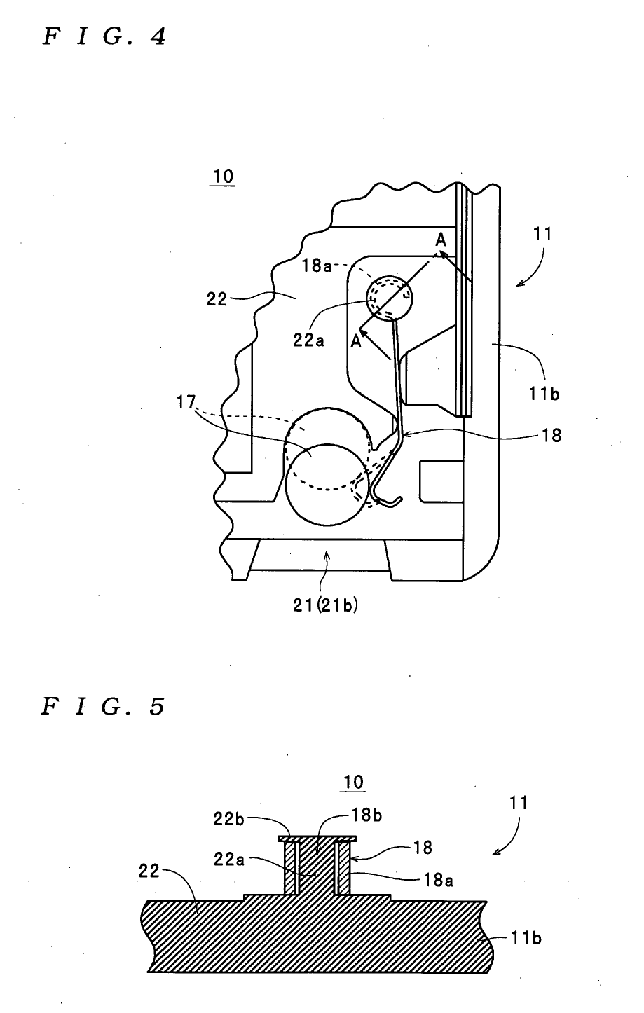

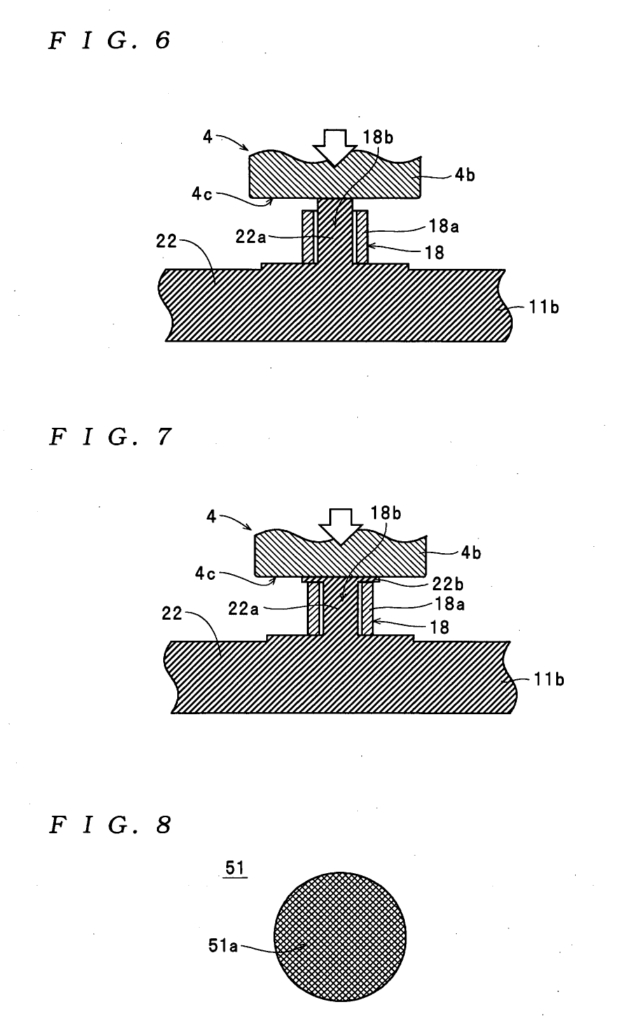

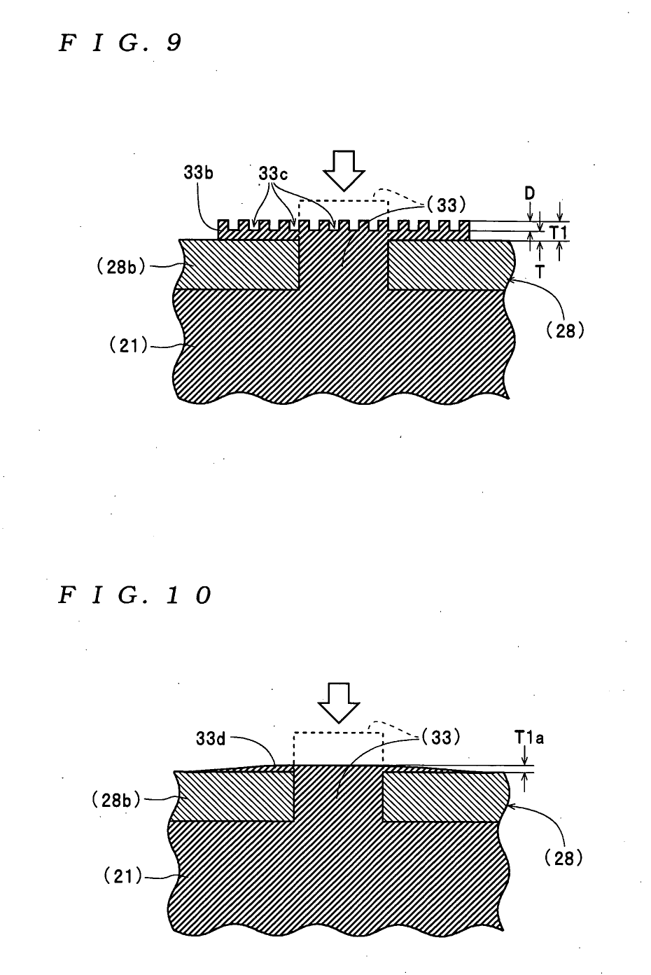

### DESCRIPTION OF REFERENCE NUMERALS

1. Ultrasonic welding apparatus

2. Moving mechanism

3. Ultrasonic vibrator

4. Horn

4a. Base end portion

4b. Front end portion

4c. Contact surface

5. Control unit

6. Base

10. Tape cartridge

11. Case main body

11a. Upper case

11b. Lower case

18. Spring member

18a. Cylindrical part

18b. Through hole

22. Base plate

22a. Attachment boss

22b. Head portion

101. Manufacturing apparatus

1. An ultrasonic welding apparatus comprising:
an ultrasonic vibrator;
an ultrasonic horn whose contact surface that contacts an object is subjected to a matte finishing process and which transmits ultrasound generated by the ultrasonic vibrator; and
a moving mechanism that moves the ultrasonic horn in a direction toward and away from the object.

2. An ultrasonic welding apparatus according to claim 1, wherein the contact surface of the ultrasonic horn is subjected to the matte finishing process so that a ten-point average roughness thereof is in a range of 10 μm to 25 μm, inclusive.

3. An ultrasonic welding apparatus according to claim 1, wherein ultrasonic welding apparatus is constructed so that by placing the contact surface of the ultrasonic horn in contact with a front end portion of a welding convex portion formed on the object in a state where the welding convex portion has been inserted through a through hole formed in another object and causing the moving mechanism to move the horn toward the welding convex portion while having the ultrasonic vibrator generate the ultrasound, the front end portion is melted and crushed into a plate-like shape to form a fixing head portion to fix the other object to the object.

4. An information recording medium manufacturing apparatus comprising: an ultrasonic vibrator; an ultrasonic horn whose contact surface that contacts an object is subjected to a matte finishing process and which transmits ultrasound generated by the ultrasonic vibrator; and a moving mechanism that moves the ultrasonic horn in a direction toward and away from the object,
wherein the information recording medium manufacturing apparatus is capable of manufacturing a cartridge-type information recording medium by placing the contact surface of the ultrasonic horn in contact with a front end portion of a welding convex portion formed on a recording medium case as the object in a state where the welding convex portion has been inserted through a through hole formed in a recording medium component and causing the moving mechanism to move the horn toward the welding convex portion while having the ultrasonic vibrator generate the ultrasound to melt and crush the front end portion into a plate-like shape to form a fixing head portion and fix the recording medium component to the recording medium case.

5. An ultrasonic welding method that fixes an object to another object by placing a contact surface of an ultrasonic horn, which has been subjected to a matte finishing process, in contact with a front end portion of a welding convex portion formed on the object in a state where the welding convex portion has been inserted through a through hole formed in the other object and moving the ultrasonic horn toward the welding convex portion while applying ultrasound to the welding convex portion via the ultrasonic horn to melt and crush the front end portion of the welding convex portion into a plate-like shape to form a fixing head portion.

6. An object on part of a surface of which a matte pattern is formed by a welding process.

7. A cartridge case including a recording medium case as an object on part of a surface of which a matte pattern is formed by a welding process.

8. A cartridge case according to claim 7, wherein the matte pattern is formed with a surface of a boss for fixing a spring as the surface.

9. An ultrasonic welding apparatus according to claim 2, wherein ultrasonic welding apparatus is constructed so that by placing the contact surface of the ultrasonic horn in contact with a front end portion of a welding convex portion formed on the object in a state where the welding convex portion has been inserted through a through hole formed in another object and causing the moving mechanism to move the horn toward the welding convex portion while having the ultrasonic vibrator generate the ultrasound, the front end portion is melted and crushed into a plate-like shape to form a fixing head portion to fix the other object to the object.
